(19) United States
(12) Patent Application Publication
(10) Pub. No.: US 2005/0289364 A1
(43) Pub. Date: Dec. 29, 2005

(54) Method and apparatus for performing a staggered spin-up process for serial advanced technology attachment devices

(75) Inventors: Robert W. Strong, Folsom, CA (US); Dong H. Thai, Elk Grove, CA (US)

Correspondence Address: LAWRENCE CHO;C/O PORTFOLIOIP, P. O. BOX 52050, MINNEAPOLIS, MN, 55402, US

(73) Assignee: Intel Corporation

(21) Appl. No.: 10/880,223

(22) Filed: Jun. 29, 2004

(51) Int. Cl. G06F 1/26

(52) U.S. Cl. 713/300

(57) ABSTRACT

A method for managing a host controller includes transmitting a first communication signal to a first port on the host controller so that a first device coupled to the first port receives power to enter an operational state. A determination is made as to whether a second port is present on the host controller. A second communication signal to the second port is transmitted after a predetermined period of time of transmitting the first communication signal to the first port so that a second device coupled to the second port receives power to enter the operational state if the second port is present.

### TECHNICAL FIELD

Embodiments of the present invention pertain to Serial Advanced Technology Attachment (SATA) devices. More specifically, embodiments of the present invention relate to a method and apparatus for performing a staggered spin-up process for SATA devices such as disk drives.

### BACKGROUND

Upon power-up, a disk drive on a computer system is spun-up to a maximum rotation speed that puts the disk drive in an operational state that allows it to function. The spinning-up of a disk drive initially requires a large amount of current draw. After a period of time, the amount of current draw required for spinning the disk drive decreases and reaches a steady state. Platforms that include numerous SATA disk drives may be presented with power system design issues related to the electronic current load presented during system power-up. The Serial ATA II: Extensions to Serial ATA 1.0 Rev 1.0 Specification (published 2003) describes a staggered spin-up process where SATA host controllers can sequence disk drive initialization and spin-up.

The staggered spin-up process described in the SATA specification initiates sequential spin-up of disk drives one at a time. The SATA specification begins spinning-up a first disk drive and waits for the first disk drive to enter a ready state prior to spinning-up a second disk drive. In order to enter into a ready state, the calibration of heads, self-testing of hardware, and other procedures are performed on a disk drive in addition to spin-up. Having to wait for these additional procedures to be performed prior to initiating spin-up of a next disk drive could significantly delay the completion of the staggered spin-up process in cases were numerous disk drives are present. This results in long periods of idleness in the computer system which is undesirable.

Thus, what is needed is an effective method and apparatus for performing a staggered spin-up of SATA disk drives where start up latencies can be reduced while still incurring the benefits of the staggered spin-up.

### BRIEF DESCRIPTION OF THE DRAWINGS

The features and advantages of embodiments of the present invention are illustrated by way of example and are not intended to limit the scope of the embodiments of the present invention to the particular embodiments shown.

FIG. 1 illustrates a block diagram of a computer system in which an embodiment of the present invention resides in.

FIG. 2 is a block diagram of a basic input output system used by a computer system according to an embodiment of the present invention.

FIG. 3 is a block diagram of a spin-up manager according to an embodiment of the present invention.

FIG. 4 is a chart illustrating current draw for an SATA device over time.

FIG. 5 is a flow chart illustrating a method for performing staggered spin-up using an abbreviated serialization technique according to an embodiment of the present invention.

FIG. 6 is a flow chart illustrating a method for performing staggered spin-up using a multi-port serialization technique according to an embodiment of the present invention.

FIG. 7 is a flowchart illustrating a method for performing staggered spin-up using an abbreviated multi-port serialization technique according to a first embodiment of the present invention.

### DETAILED DESCRIPTION

In the following description, for purposes of explanation, specific nomenclature is set forth to provide a thorough understanding of embodiments of the present invention. However, it will be apparent to one skilled in the art that these specific details may not be required to practice the embodiments of the present invention. In other instances, well-known circuits, devices, and programs are shown in block diagram form to avoid obscuring embodiments of the present invention unnecessarily.

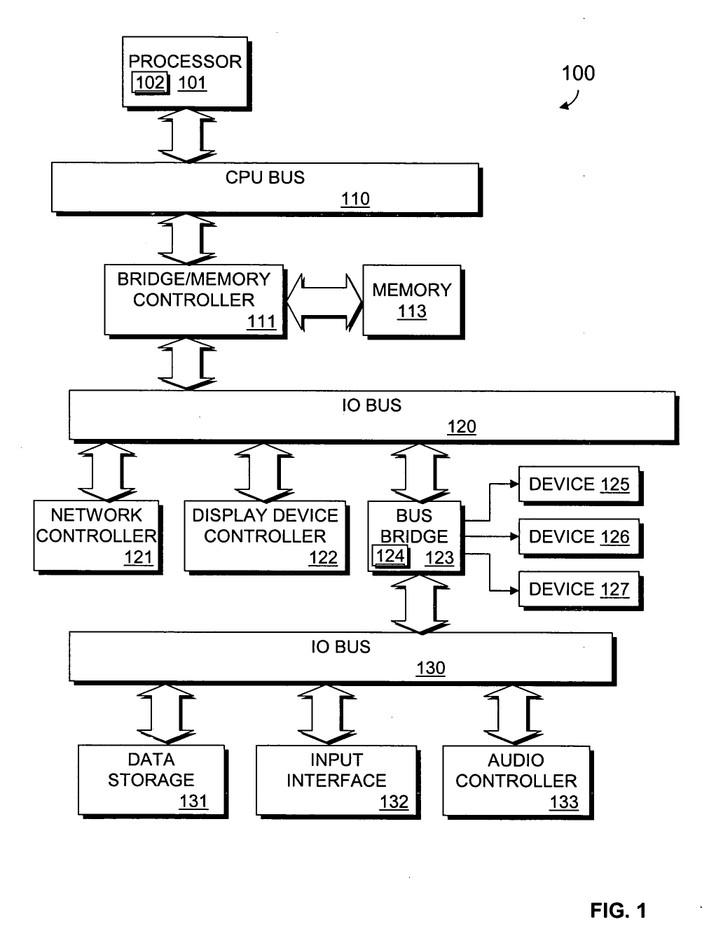

FIG. 1 is a block diagram of an exemplary computer system 100 in which an embodiment of the present invention resides. The computer system 100 includes a processor 101 that processes data signals. The processor 101 may be a complex instruction set computer microprocessor, a reduced instruction set computing microprocessor, a very long instruction word microprocessor, a processor implementing a combination of instruction sets, or other processor device. FIG. 1 shows the computer system 100 with a single processor. However, it is understood that the computer system 100 may operate with multiple processors. The processor 101 is coupled to a CPU bus 110 that transmits data signals between processor 101 and other components in the computer system 100.

The computer system 100 includes a memory 113. The memory 113 may be a dynamic random access memory device, a static random access memory device, or other memory device. The memory 113 may store instructions and code represented by data signals that may be executed by the processor 101. According to one embodiment, the memory 113 includes read only memory. The read only memory stores important instructions and code represented by data signals that may be executed by the processor 101. The computer system basic input output system (BIOS) may be stored on the read only memory.

A cache memory 102 resides inside processor 101 that stores data signals stored in memory 113. The cache 102 speeds up memory accesses by the processor 101 by taking advantage of its locality of access. In an alternate embodiment of the computer system 100, the cache 102 resides external to the processor 101.

A bridge memory controller 111 is coupled to the CPU bus 110 and the memory 113. The bridge memory controller 111 directs data signals between the processor 101, the memory 113, and other components in the computer system 100 and bridges the data signals between the CPU bus 110, the memory 113, and a first input output (IO) bus 120.

The first IO bus 120 may be a single bus or a combination of multiple buses. The first IO bus 120 provides communication links between components in the computer system 100. A network controller 121 is coupled to the first IO bus 120. The network controller 121 may link the computer system 100 to a network of computers (not shown) and supports communication among the machines. A display device controller 122 is coupled to the first IO bus 120. The display device controller 122 allows coupling of a display device (not shown) to the computer system 100 and acts as an interface between the display device and the computer system 100.

A second IO bus 130 may be a single bus or a combination of multiple buses. The second IO bus 130 provides communication links between components in the computer system 100. A data storage device 131 is coupled to the second IO bus 130. The data storage device 131 may be a hard disk drive, a floppy disk drive, a CD-ROM device, a flash memory device or other mass storage device. An input interface 132 is coupled to the second IO bus 130. The input interface 132 may be, for example, a keyboard and/or mouse controller or other input interface. The input interface 132 may be a dedicated device or can reside in another device such as a bus controller or other controller. The input interface 132 allows coupling of an input device to the computer system 100 and transmits data signals from an input device to the computer system 100. An audio controller 133 is coupled to the second IO bus 130. The audio controller 133 operates to coordinate the recording and playing of sounds.

A bus bridge 123 couples the first IO bus 120 to the second IO bus 130. The bus bridge 123 operates to buffer and bridge data signals between the first IO bus 120 and the second IO bus 130. According to an embodiment of the computer system 100, the bus bridge 123 includes a host controller 124. The host controller 124 may include a plurality of ports that may be used to interface a plurality of devices. Block 125 represents a first device. Block 126 represents a second device. Block 127 represents an nth device, where n may be any number. The host controller 124 may operate to communicate and control the devices 125-127. According to an embodiment of the bus bridge 123, the host controller 124 may be an SATA host controller, and the devices 125-127 may be SATA devices. The SATA devices 125-127 may be, for example, SATA disk drives.

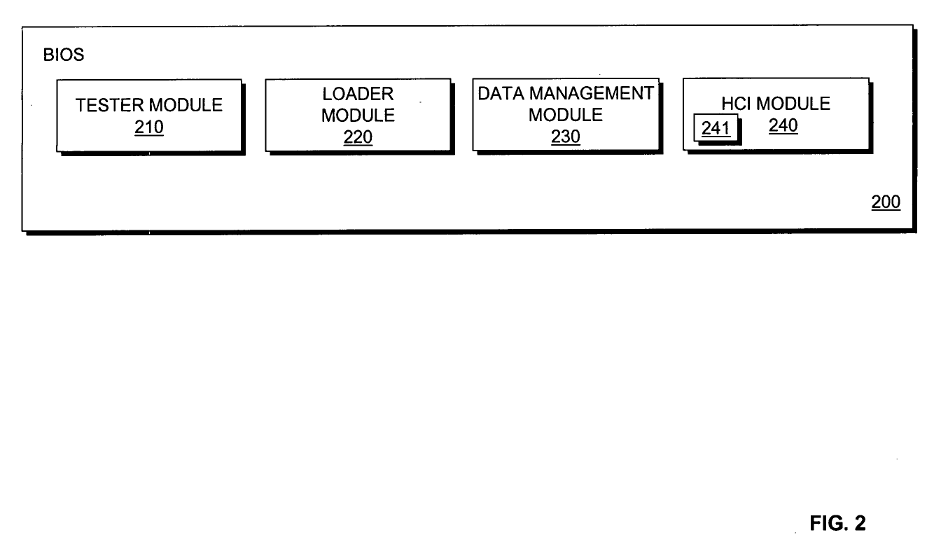

FIG. 2 is a block diagram of a BIOS 200 used by a computer system according to an embodiment of the present invention. The BIOS 200 shown in FIG. 2 may be used to implement the BIOS stored in the memory 113 (shown in FIG. 1). The BIOS 200 is a program that is run when a computer system is booted up. The BIOS 200 may include a tester module (TM) 210. The tester module 210 performs a power-on self test (POST) to determine whether the components on the computer system are operational.

The BIOS 200 may include a loader module 220. The loader module 220 locates and loads programs and files to be executed by a processor on the computer system. The programs and files may include, for example, boot programs, system files (initial system file, system configuration file), and the operating system.

The BIOS 200 may include a data management module 230. The data management module 230 manages data flow between the operating system and components on the computer system 100. The data management module 230 may operate as an intermediary between the operating system and components on the computer system and operate to direct data to be transmitted directly between components on the computer system.

The BIOS 200 may include a host controller interface (HCI) module 240. The host controller interface module 240 communicates with a host controller in the system and operates to configure and manage the devices coupled to the host controller. It should be appreciated that the host controller interface module 240 may be an SATA host controller interface module that operates to configure and manage SATA devices coupled to the SATA host controller. The host controller interface module 240 includes a staggered spin-up manager 241. The staggered spin-up manager 241 coordinates the spin-up of devices on the host controller. According to a first embodiment of the host controller interface module 240, the staggered spin-up manager 241 initiates spin-up of a plurality of devices sequentially where spin-up of each device is initiated after a predetermined period of time after the initiation of spin-up of a previous disk drive. According to a second embodiment of the host controller interface module 240, the staggered spin-up manager 241 initiates spin-up of a first plurality of devices simultaneously. The staggered spin-up manager 241 initiates spin-up of a second plurality of devices simultaneously after initiating the spin-up of the first plurality of devices.

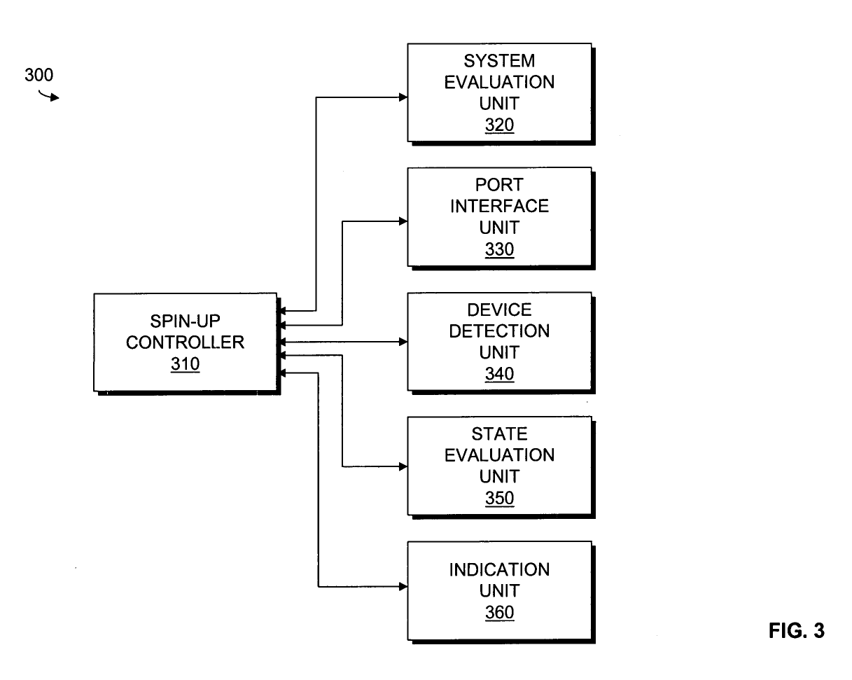

FIG. 3 is a block diagram of a staggered spin-up manager 300 according to an embodiment of the present invention. The staggered spin-up manager 300 may be used to implement the staggered spin-up manager 241 shown in FIG. 2. The staggered spin-up manager 300 includes a spin-up controller 310. The spin-up controller 310 identifies which devices to initiate spin-up and at what time.

The staggered spin-up manager 300 includes a system evaluation unit 320. The system evaluation unit 320 identifies information about a computer system. The system evaluation unit 320 may identify, for example, a number of ports that are on a host controller, a maximum number of devices that a computer system power supply is capable of spinning-up simultaneously (MS), an amount of time after the initiation of spin-up where the current draw for a device has reached its maximum and has declined to an extent where a spin-up of a next device may be performed without adversely affecting the power supply (tₙ), and/or other information. The system evaluation unit 320 may identify system information by accessing information about the system stored in the BIOS, components in the computer system, or in the system evaluation unit 320 itself. The system information may be stored on a system information list.

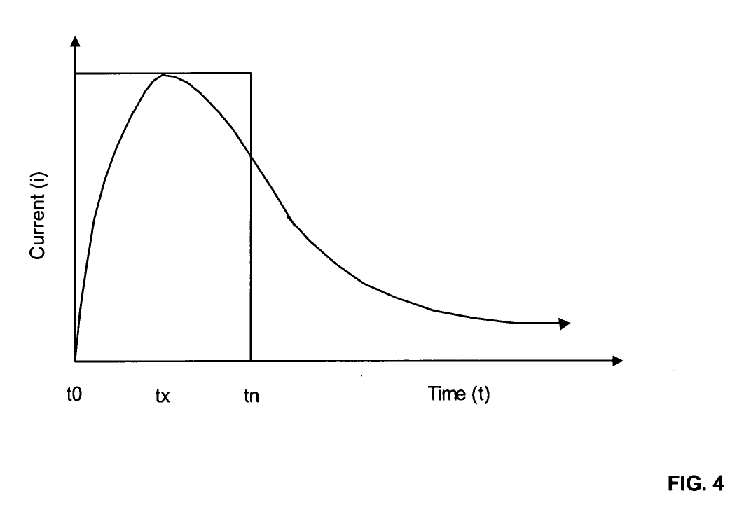

FIG. 4 is a graph illustrating the current draw for an SATA device over time. At time t₀, no current is supplied to the SATA device. The current required by the SATA device to rotate its spindles reaches its peak at time tₓ. After time tₓ the current draw for the SATA device declines as the spindles approach the maximum rotation speed. There is a time tₙ after tₓ where the current draw for the SATA device has declined to an extent where a spin-up of a next SATA device may be performed without adversely affecting the power supply of the computer system. For a power supply capable of spinning-up a first plurality of SATA devices simultaneously, there similarly is a time tₙ where the current draw for the first plurality of SATA devices has declined to an extent where spin-up of a next plurality of SATA devices may be performed without adversely affecting the power supply of the system. According to an embodiment of the present invention, the value for tₙ is less than or equal to 30 seconds.

Referring back to FIG. 3, the staggered spin-up manager 300 includes a port interface unit 330. The port interface unit 330 may transmit a communication signal to one or more ports on a host controller. The communication signal may prompt a device coupled to a port on the host controller to spin-up. A device is spun-up when it reaches a maximum rotation speed that puts the disk drive in an operational state. According to an embodiment of the present invention where the host controller is a SATA host controller, the port interface unit 330 transmits a COMRESET signal that prompts an SATA device coupled to a port on the SATA host controller to spin-up.

The staggered spin-up manager 300 includes a device detection unit 340. The device detection unit 340 detects a presence of a device on a port on a host controller. According to an embodiment of the present invention where the host controller is a SATA host controller, the device detection unit 340 detects a COMINIT signal transmitted by an SATA device on a port on the SATA host controller. An SATA device transmits a COMINIT signal in response to receiving a COMRESET signal. In one embodiment, a status bit in the SATA host controller is designated for each port. The status bit may be set in response to an SATA device indicating its presence though its assertion of the COMINIT signal. For example, the COMINIT signal may be transmitted up to 10 msec after receiving the COMRESET signal.

The staggered spin-up manager 300 includes a state evaluation unit 350. The state evaluation unit 350 determines whether devices coupled to a host controller are in a ready state. According to an embodiment of the present invention where the host controller is an SATA host controller, an SATA device is in a ready state after it has reached its maximum rotation speed, calibrated its heads, and has self-tested its hardware. In one embodiment, a status bit in the SATA host controller is designated for each port. The status bit may be set by an SATA device to indicate that it is in a ready state. In this embodiment, the state evaluation unit 350 may operate to read status bits corresponding to the ports on the SATA host controller. In some instances, SATA devices may take up to 30 seconds after receiving the COMRESET signal to enter into the ready state.

The staggered spin-up manager 300 includes an indication unit 360. The indication unit 360 generates an indication to components in a computer system that all devices in a ready state are available.

According to a first embodiment of the staggered spin-up manager 300, the spin-up controller 310 directs the port interface unit 330 to transmit a communication signal to a first port on the host controller so that a first device coupled to the first port receives power to enter an operational state. The spin-up controller 310 directs the port interface unit 330 to transmit a communication signal to the second port after a predetermined period of time (tₙ determined by the system evaluation unit 320) so that a second device coupled to the second port receives power to enter the operational state if the second port is present. After all the ports on the host controller have been serviced, a determination is made by the device detection unit 340 as to whether any devices are coupled to the ports of the host controller. If a device is coupled to a port on the host controller, the state evaluation unit 350 determines when the device is in a ready state. When all the devices on the host controller are in the ready state, the spin-up controller 310 directs the indication unit 360 to generate an indication that the staggered spin-up procedure is completed and that all of the devices are in a ready state.

According to a second embodiment of the staggered spin-up manager 300, the spin-up controller 310 directs the port interface unit 320 to transmit communication signals to a first plurality of ports so that devices coupled to the first plurality of ports receive power to enter operational states. The number of the plurality of ports may be a maximum number of devices that a system power supply is capable of spinning-up simultaneously as determined by the system evaluation unit 320. The spin-up controller 310 directs the port interface unit 330 to transmit a communication signal to the one or more additional ports so that a device on the one or more additional ports receives power to enter the operational state. According to one aspect of this embodiment, a determination is made by the device detection unit 340 as to whether any devices are coupled to the first plurality of ports on the host controller. If a device is coupled to one of the first plurality of ports on the host controller, the state evaluation unit 350 determines when the device is in a ready state. When all the devices coupled to the first plurality of ports are in the ready state, the one or more additional ports are serviced. According to a second aspect of this embodiment, the spin-up controller 310 directs the port interface unit 330 to transmit a communication signal to the one or more additional ports after a predetermined period of (tₙ determined by the system evaluation unit 320). After all of the ports on the host controller have been serviced, the state evaluation unit 350 determines whether the devices on the host controller are in a ready state.

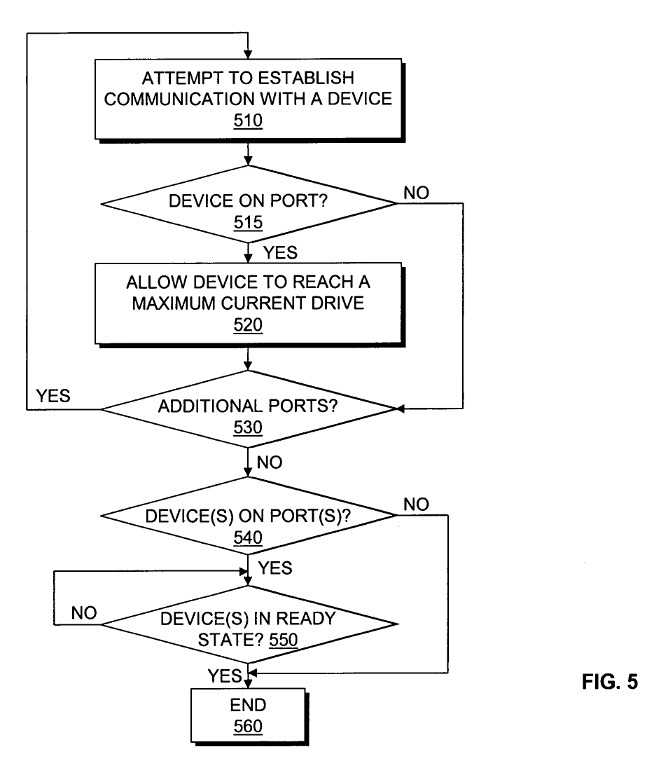

FIG. 5 is a flow chart illustrating a method for performing staggered spin-up using an abbreviated serialization technique according to an embodiment of the present invention. At 510, an attempt is made to establish communication with a device where there is no current communication. This may be achieved by transmitting a communication signal to a port on a host controller so that a device coupled to the port receives power to enter an operational state. By transmitting the communication signal to the port of the host controller, the device (if present) begins to draw current and spin-up. According to an embodiment of the present invention where the host controller is an SATA host controller and the device is an SATA device, such as a disk drive, the communication signal may be a COMRESET signal.

At 515, it is determined whether a device is present on a port where communication has been attempted to be established. According to an embodiment of the present invention where the host controller is an SATA host controller and the device is an SATA device, this may be achieved by detecting receipt of a COMINIT signal generated by an SATA device on a port. If a device is present on a port where communication has been attempted to be established, control proceeds to 520. If a device is not present on a port where communication has been attempted to be established, control proceeds to 530.

At 520, the device is allowed to reach a maximum current draw. According to an embodiment of the present invention, a time period, tₙ, after the device has reached the maximum current draw is determined where establishing communication with a next device may be achieved without adversely affecting the power supply. The predetermined time period transpires before an attempt is made to establish communication with a next device.

At 530, it is determined whether additional ports are present on the host controller. According to an embodiment of the present invention, this information may be determined by referencing a system information list. If additional ports are present on the host controller, control returns to 510. If additional ports are not present on the host controller, control proceeds to 540.

At 540, it is determined whether a device is present on a port where communication has been attempted to be established. According to an embodiment of the present invention where the host controller is an SATA host controller and the device is an SATA device, this may be achieved by detecting receipt of a COMINIT signal generated by an SATA device on a port. If one or more device(s) is present on a port where communication has been attempted to be established, control proceeds to 550. If one or more device(s) is not present on a port where communication has been attempted to be established, control proceeds to 560.

At 550, it is determined whether the device(s) determined to be present on the port(s) are in a ready state. According to an embodiment of the present invention, this may be achieved by checking a ready bit corresponding to the port(s) on the host controller. If the device(s) are determined to be in a ready state, control proceeds to 560. If the device(s) are determined to not be in the ready state, control returns to 550. According to an embodiment of the present invention, all devices shall be in the ready state within a period of time that shall not exceed 30 seconds and where the period time begins when a device(s) detects the communication signal transmitted by the port interface unit 330.

At 560, the staggered spin-up procedure is terminated as shown. According to an embodiment of the present invention, an indication may be generated to indicate that all devices in a ready state are available.

Consider an SATA host controller with four ports populated with four SATA devices each requiring 5 seconds from initial power on to reach a ready state. The four SATA devices would require at least 20 seconds to spin-up if accomplished in a serialized manner. Each of the preceeding SATA devices would be required to be in a ready state before initiating spin-up of subsequent (e.g. do SATA device 1, then do SATA device 2, then do SATA device 3, etc) SATA devices (4 drives×5 seconds). The method illustrated in FIG. 5 may be used to reduce the time required for the four SATA devices to spin-up. If tₙ for each of the four drives is determined to be 2 seconds, the time required for the four SATA devices to spin-up would be approximately 8 seconds (4 drives×2 seconds).

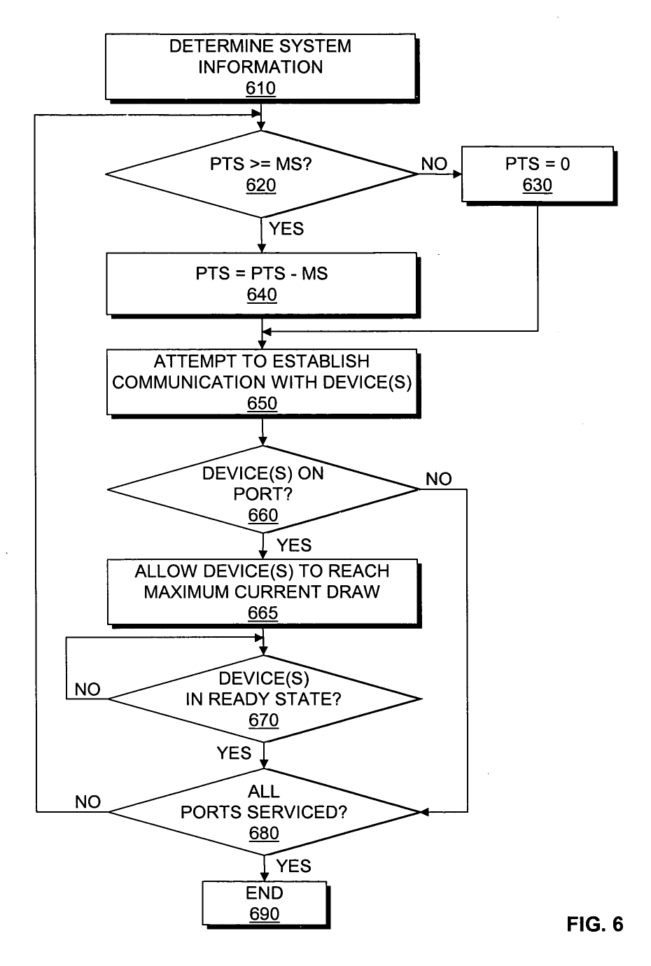

FIG. 6 is a flow chart illustrating a method for performing staggered spin-up using a multi-port serialization technique according to an embodiment of the present invention. At 610, system information is determined. The system information may include a number of ports to service on a host controller (PTS), a maximum number of devices that a system power supply is capable of spinning-up simultaneously (MS), an amount of time after the initiation of spin-up where the current draw for a device has reached its maximum and has declined to an extent where a spin-up of a next device may be performed without adversely affecting the power supply (tₙ). It should be appreciated that where more than one device may be spun-up simultaneously, tₙ may represent an amount of time after the initiation of spin-up of the more than one device where current draw for the devices has reached a maximum and has declined to an extent where spin-up of a second plurality of maximum number of devices may be performed without adversely affecting the power supply. According to an embodiment of the present invention, this information may be referenced from a system information list.

At 620, it is determined whether the number of ports to service is greater or equal to the maximum number of devices that the system power supply is capable of spinning-up simultaneously. If the number of ports to service is not greater than the maximum number of devices that the system power supply is capable of spinning-up simultaneously, control proceeds to 630. If the number of ports to service is greater than the maximum number of devices that the system power supply is capable of spinning-up simultaneously, control proceeds to 640.

At 630, the number of ports to service is set to zero. Control proceeds to 650.

At 640, the number of ports to service is set to the number of ports to service minus the maximum number of devices that the system power supply is capable of spinning-up simultaneously.

At 650, an attempt is made to establish communication with the maximum number of devices that the system power supply is capable of spinning-up simultaneously. The devices selected to establish communication with are devices with which there have been no communication. This may be achieved by transmitting a communication signal to a port on a host controller so that a device coupled to the port receives power to enter an operational state. By transmitting the communication signal to the port of the host controller, the device begins to draw current and spin-up. According to an embodiment of the present invention where the host controller is an SATA host controller and the device is an SATA device, such as a disk drive, the communication signal may be a COMRESET signal.

At 660, it is determined whether a device(s) is present on a port(s) where communication has been attempted to be established. According to an embodiment of the present invention where the host controller is an SATA host controller and the device is an SATA device, this may be achieved by detecting receipt of a COMINIT signal generated by a device on a port. If one or more device(s) is present on a port where communication has been attempted to be established, control proceeds to 665. If one or more device(s) is not present on a port where communication has been attempted to be established, control proceeds to 680.

At 665, the devices are allowed to reach a maximum current draw. According to an embodiment of the present invention, the predetermined time period tₙ transpires before an attempt is made to establish communication with a next device.

At 670, it is determined whether the device(s) determined to be present on the port(s) are in a ready state. According to an embodiment of the present invention, this may be achieved by checking a ready bit corresponding to the port(s) on the host controller. If the device(s) are determined to be in a ready state, control proceeds to 680. If the device(s) are determined to not be in the ready state, control returns to 670. A device(s) shall enter a ready state within a period of time that shall not exceed 30 seconds.

At 680, it is determined whether all of the ports have been serviced. If not all of the ports have been serviced, control returns to 620. If all of the ports have been serviced, control proceeds to 690.

At 690, the staggered spin-up procedure is terminated as shown. According to an embodiment of the present invention, an indication may be generated to indicate that all devices in a ready state are available.

Consider an SATA host controller having eight ports, and populated with eight SATA devices each requiring 5 seconds from initial power on to reach a ready state. The eight SATA devices would require 40 seconds to enter the ready state (8 drives×5 seconds), if spun up in a serialized manner. The method illustrated in FIG. 6 may be used to reduce the time required for the eight SATA devices to enter into a ready state. If a power supply is determined to have a duty cycle that allows the simultaneously spin-up of three SATA devices (MS), groups of three SATA devices may be spun-up together three times. The time required for the eight SATA devices to enter the ready state would be approximately 15 seconds (3 groups×5 seconds). The method illustrated in FIG. 6 results in a 25 second savings.

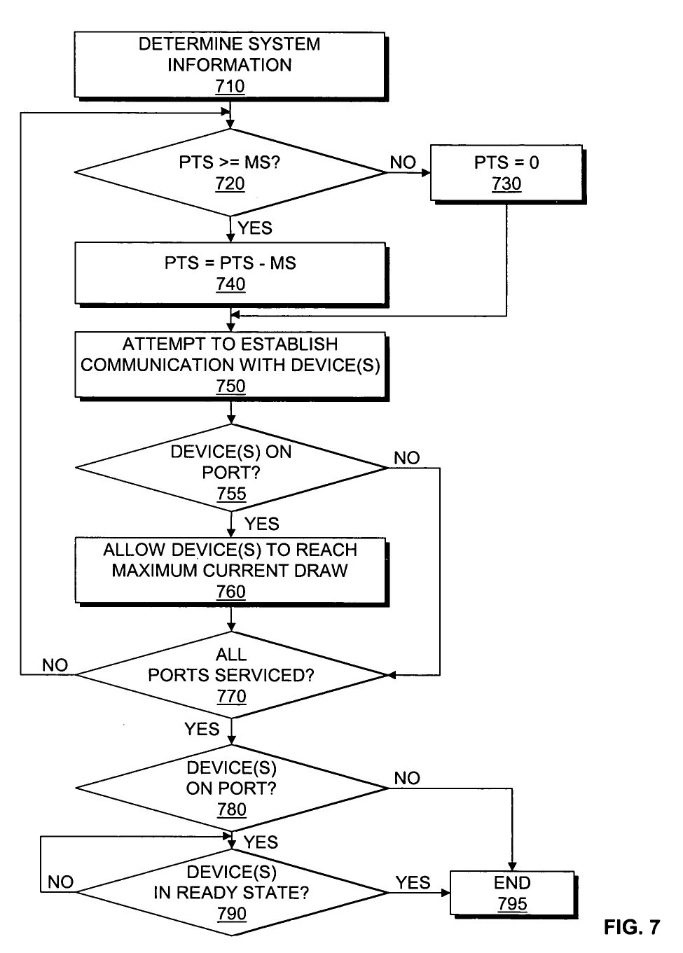

FIG. 7 is a flowchart illustrating a method for performing staggered spin up using an abbreviated multi-port serialization technique according to a first embodiment of the present invention. At 710, system information is determined. The system information may include a number of ports to service on a host controller (PTS), a maximum number of devices that a system power supply is capable of spinning-up simultaneously (MS), an amount of time after the initiation of spin-up where the current draw for a device has reached its maximum and has declined to an extent where a spin-up of a next device may be performed without adversely affecting the power supply (tₙ). It should be appreciated that where more than one device may be spun-up simultaneously, tₙ may represent an amount of time after the initiation of spin-up of the more than one device where current draw for the devices has reached a maximum and has declined to an extent where spin-up of a second plurality of maximum number of devices may be performed without adversely affecting the power supply. According to an embodiment of the present invention, this information may be referenced from a system information list.

At 720, it is determined whether the number of ports to service is greater or equal to the maximum number of devices that the system power supply is capable of spinning-up simultaneously. If the number of ports to service is not greater than the maximum number of devices that the system power supply is capable of spinning-up simultaneously, control proceeds to 730. If the number of ports to service is greater than the maximum number of devices that the system power supply is capable of spinning-up simultaneously, control proceeds to 740.

At 730, the number of ports to service is set to zero. Control proceeds to 750.

At 740, the number of ports to service is set to the number of ports to service minus the maximum number of devices that the system power supply is capable of spinning-up simultaneously.

At 750, an attempt is made to establish communication with the maximum number of devices that the system power supply is capable of spinning-up simultaneously. The devices selected to establish communication with are devices with which there have been no communication. This may be achieved by transmitting a communication signal to a port on a host controller so that a device coupled to the port receives power to enter an operational state. By transmitting the communication signal to the port of the host controller, the device begins to draw current and spin-up. According to an embodiment of the present invention where the host controller is an SATA host controller and the device is an SATA device, such as a disk drive, the communication signal may be a COMRESET signal.

At 755, it is determined whether a device is present on a port where communication has been attempted to be established. According to an embodiment of the present invention where the host controller is an SATA host controller and the device is an SATA device, this may be achieved by detecting receipt of a COMINIT signal generated by an SATA device on a port. If a device is present on a port where communication has been attempted to be established, control proceeds to 760. If a device is not present on a port where communication has been attempted to be established, control proceeds to 770.

At 760, the devices are allowed to reach a maximum current draw. According to an embodiment of the present invention, the predetermined time period tₙ transpires before an attempt is made to establish communication with a next device.

At 770, it is determined whether all ports have been serviced. If all ports have not been serviced, control returns to 720. If all ports have been serviced, control proceeds to 780.

At 780, it is determined whether a device is present on a port where communication has been attempted to be established. According to an embodiment of the present invention where the host controller is an SATA host controller and the device is an SATA device, this may be achieved by detecting receipt of a COMINIT signal generated by an SATA device on a port. If one or more device(s) is present on a port where communication has been attempted to be established, control proceeds to 790. If one or more device(s) is not present on a port where communication has been attempted to be established, control proceeds to 795.

At 790, it is determined whether the device(s) determined to be present on the port(s) are in a ready state. According to an embodiment of the present invention, this may be achieved by checking a ready bit corresponding to the port(s) on the host controller. If the device(s) are determined to be in a ready state, control proceeds to 795. If the device(s) are determined to not be in the ready state, control returns to 790. If after 30 seconds, all device(s) are determined to not be in the ready state, control proceeds to 795.

At 795, the staggered spin-up procedure is terminated as shown. According to an embodiment of the present invention, an indication may be generated to indicate that all devices in a ready state are available.

Consider an SATA host controller having eight ports and populated with eight SATA devices each requiring 5 seconds from initial power on to reach a ready state. The eight SATA devices would require 40 seconds to enter the ready state (8 drives×5 seconds) in a serial fashion. The method illustrated in FIG. 6 may be used to reduce this time to 15 seconds. The method illustrated in FIG. 7 may be used to further reduce the time required for the eight SATA devices to enter into the ready state. If tₙ for each of the eight drives is determined to be 2 seconds, this may be used to determine a time to initiate spin-up of the second and third groups of SATA devices instead of waiting for a ready state. Thus, an additional 6 seconds may be subtracted from the time computed with reference to the approach used in FIG. 7 ([5 seconds (to wait for a ready state)−2 seconds (to wait for tₙ)]*2). The total spin up time is 9 seconds in this example.

FIGS. 5-7 are flow charts illustrating embodiments of the present invention. Some of the procedures illustrated in the figures may be performed sequentially, in parallel or in an order other than that which is described. It should be appreciated that not all of the procedures described are required, that additional procedures may be added, and that some of the illustrated procedures may be substituted with other procedures.

In the foregoing specification, the embodiments of the present invention have been described with reference to specific exemplary embodiments thereof. It will, however, be evident that various modifications and changes may be made thereto without departing from the broader spirit and scope of the embodiments of the present invention. The specification and drawings are, accordingly, to be regarded in an illustrative rather than restrictive sense.

1. A method for managing a host controller, comprising:
transmitting a first communication signal to a first port on the host controller so that a first device coupled to the first port receives power to enter an operational state;
determining whether a second port is present on the host controller; and
transmitting a second communication signal to the second port after a predetermined period of time of transmitting the first communication signal to the first port so that a second device coupled to the second port receives power to enter the operational state if the second port is present.

2. The method of claim 1, wherein the first and second devices are Serial Advanced Technology Attachment (SATA) disk drives.

3. The method of claim 1, wherein transmitting the first communication signal to the first port comprises transmitting a COMRESET signal.

4. The method of claim 1, further comprising determining whether a device is coupled to one of the first and the second ports.

5. The method of claim 4, wherein determining whether the device is coupled to one of the first and second ports comprises determining whether a COMINIT signal has been sent.

6. The method of claim 1, further comprising determining whether all devices have entered a ready state upon determining that the device is coupled to one of the first and the second ports.

7. The method of claim 3, further comprising generating an indication that devices in a ready state are available.

8. The method of claim 1, wherein determining whether the second port is present comprises referencing a system information list.

9. The method of claim 1, wherein the predetermined period of time is an amount of time where a device has already reached a maximum amount of current draw.

10. The method of claim 1, wherein the predetermined period of time is less than or equal to 30 seconds.

11. The method of claim 1, further comprising:
determining whether a third port is present; and
transmitting a third communication signal to the third port after a predetermined period of time of transmitting the second communication signal to the second port so that a third device coupled to the third port receives power to enter the operational state if the third port is present.

12. A method for managing a host controller, comprising:
transmitting first communication signals to a first plurality of ports so that devices coupled to the first plurality of ports receive power to enter operational states;
determining whether one or more additional ports are present; and
transmitting second communication signals to the one or more ports so that a device on the one or more additional ports receives power to enter the operational state if the one or more additional ports are present.

13. The method of claim 12, wherein the devices are Serial Advanced Technology Attachment (SATA) disk drives.

14. The method of claim 12, further comprising determining whether one or more devices is coupled to the first plurality of ports.

15. The method of claim 12, wherein transmitting the second communication signal to the one or more ports is performed after determining that the devices coupled to the first plurality of ports have entered a ready state.

16. The method of claim 15, further comprising generating an indication that the devices coupled to the first plurality of ports have entered the operational state.

17. The method of claim 12, wherein transmitting the second communication signal to the one or more additional ports is performed after a predetermined period of time.

18. The method of claim 17, wherein the predetermined period of time is an amount of time where a device has already reached a maximum amount of current draw.

19. The method of claim 17, wherein the predetermined period of time is less than or equal to 30 seconds.

20. The method of claim 12, further comprising determining whether all devices have entered a ready state.

21. The method of claim 20, further comprising generating an indication that all devices in a ready state are available.

22. An article of manufacture comprising a machine accessible medium including sequences of instructions, the sequences of instructions including instructions which when executed causes the machine to perform:
transmitting first communication signals to a first plurality of ports so that devices coupled to the first plurality of ports receive power to enter operational states;
determining whether one or more additional ports are present; and
transmitting second communication signal to the one or more ports so that a device on the one or more additional ports receives power to enter the operational state if the one or more additional ports are present.

23. The article of manufacture of claim 22, wherein transmitting the second communication signals to the one or more ports is performed after determining that the devices coupled to the first plurality of ports have entered a ready state.

24. The article of manufacture of claim 22, wherein transmitting the second communication signals to the one or more additional ports is performed after a predetermined period of time.

25. A staggered spin-up manager, comprising:
a port interface unit to transmit a first communication signal to a first port on a host controller so that a first device coupled to the first port receives power to enter an operational state, and to transmit a second communication signal to the second port after a predetermined period of time of transmitting the first communication signal to the first port so that a second device coupled to the second port receives power to enter the operational state; and
a state evaluation unit to determine whether the first device and the second device are in a ready state.

26. The staggered spin-up manager of claim 25, further comprising a device detection unit to determine a presence of the first and second devices.

27. The staggered spin-up manager of claim 25, further comprising a system evaluation unit to store a value of the predetermined period of time.

28. The staggered spin-up manager of claim 25, further comprising an indication unit to generate an indication that the first device and second device are in a ready state.

29. A computer system, comprising:
a processor;
a bus; and
a staggered spin-up manager that includes a port interface unit to transmit a first communication signal to a first port on a host controller so that a first device coupled to the first port receives power to enter an operational state, and to transmit a second communication signal to the second port after a predetermined period of time of transmitting the first communication signal to the first port so that a second device coupled to the second port receives power to enter the operational state, and a state evaluation unit to determine whether the first device and the second device are in a ready state.

30. The computer system of claim 29, wherein the staggered spin-up manager further comprises a device detection unit to determine a presence of the first and second devices.
